(19) United States
(12) Patent Application Publication
(10) Pub. No.: US 2015/0119132 A1
(43) Pub. Date: Apr. 30, 2015

(54) IMAGE INTERACTION

(71) Applicant: Timba London Limited, London (GB)

(72) Inventor: Francisco Matias REYNAL PASMAN, Buenos Aires (BR)

(21) Appl. No.: 14/521,741

(22) Filed: Oct. 23, 2014

(30) Foreign Application Priority Data
Oct. 23, 2013 (GB) 1318770.3

(51) Int. Cl. A63F 13/5372; G06F 3/0484; H04L 29/08; G06F 3/0481

(52) U.S. Cl. CPC A63F 13/5372; G06F 3/0481; G06F 3/04842; H04L 67/10
USPC 463/25

(57) ABSTRACT

In one described example, at a computing device, a selection corresponding to at least one pixel in an image by a user is received. The image is displayed on a display device accessible to the user. The selection is performed using an input device accessible to the user. At the computing device, it is then determined if the selection corresponds to at least one predetermined pixel in the image. Responsive to a determination that the selection corresponds to said at least one predetermined pixel, a reward item is assigned to the user. Responsive to a determination that the at least one pixel does not correspond to said at least one predetermined pixel, the reward item is not assigned to the user.

### CROSS-REFERENCE TO RELATED APPLICATIONS

This application claims the benefit under 35 U.S.C. §119(a) to GB patent application no. 1318770.3, filed on Oct. 23, 2013, the entire contents of which is incorporated herein by reference.

### BACKGROUND OF THE INVENTION

1. Field of the Invention

The present invention relates to a method and system of interacting with data representative of an image.

2. Background

Online games have grown in popularity in recent years. When playing these games, a user of a computing device interacts with a server across a network. The server receives interactions from the user and provides game content to the computing device. The computing device may be any one of a desktop computer, a smartphone or a tablet computer. Advances in wireless networking technology, and the installation of suitable infrastructure for high-speed access, means that users can play online games from locations all around the world and from both mobile and static bases. Large portions of the world are expected to come online in the next five to ten years.

### SUMMARY

According to a first aspect of the present invention, there is provided a computer-implemented method comprising receiving, at a computing device, a selection corresponding to at least one pixel in an image by a user, the image being displayed on a display device accessible to the user, the selection being performed using an input device accessible to the user; determining, at the computing device, if the selection corresponds to at least one predetermined pixel in the image; and responsive to a determination that the selection does correspond to said at least one predetermined pixel, assigning a reward item to the user, wherein responsive to a determination that the selection does not correspond to said at least one predetermined pixel, the reward item is not assigned to the user.

According to a second aspect of the present invention there is provided a method comprising receiving data representative of an image from a server computing device; displaying, based on the received data, a representation of the image on a display device associated with a user computing device; receiving, from an input device associated with the user computing device, a selection corresponding to at least one pixel in the image by a user, the selection being made in relation to the displayed representation; sending, from the user computing device to the server computing device, data representative of the selection; and receiving data from the server computing device indicative of whether the selection corresponds to at least one predetermined pixel in the image, including receiving data indicative of an assignment of a reward item to the user if the selection corresponds to at least one predetermined pixel in the image.

According to a third aspect of the present invention there is provided a computing system comprising a server computing device communicatively coupled to a computer-readable storage medium and comprising an interface to receive data indicative of a selection corresponding to at least one pixel from a user, the server computing device having access to data representative of an image, said data being stored on the computer-readable storage medium and comprising an indication of at least one predetermined pixel in the image, the server computer device being arranged to determine, based on the data stored on the computer-readable storage medium, if received data indicative of a selection corresponding to at least one pixel from a user comprises a selection corresponding to said at least one predetermined pixel in the image, and to, responsive to a positive determination, send data to the user indicating that they have been assigned a reward item.

Further features and advantages of the invention will become apparent from the following description of certain examples, which is made with reference to the accompanying drawings.

### BRIEF DESCRIPTION OF THE DRAWINGS

FIG. 1 is a schematic diagram showing a computer system for interacting with an image according to an example;

FIG. 2 is a schematic diagram showing a first user interface for interacting with an image according to an example;

FIG. 3 is a schematic diagram showing a second user interface for interacting with an image according to an example;

FIG. 4 is a flow chart showing a method of interacting with an image according to an example; and

FIG. 5 is a schematic diagram showing a user interacting with an image according to an example.

### DETAILED DESCRIPTION OF CERTAIN INVENTIVE EMBODIMENTS

Certain examples described herein enable one or more users of a computing device to interact with an image in a manner that conditionally assigns a reward item to the user depending on the interaction. These examples may be implemented over one or more networks such as the Internet. Certain examples may be easily implemented on a number of different computing devices, including desktop computers, smartphones, games consoles and tablets. Certain examples may also be easily understood by a plurality users that each use a different language for communication. Certain examples further provide new methods for offering goods and providing promotions over the Internet.

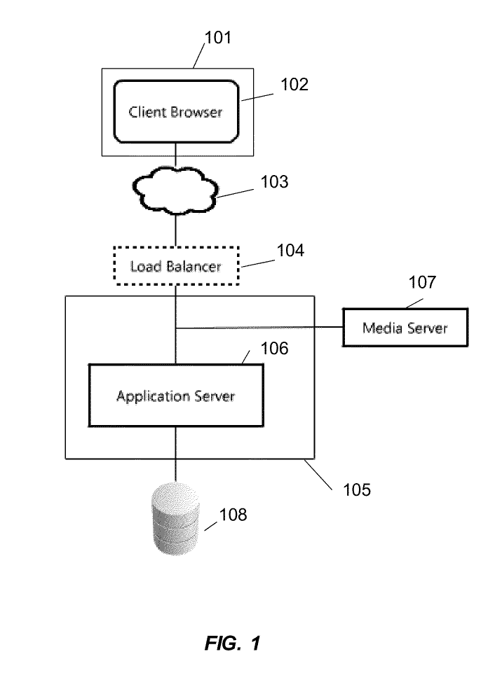

FIG. 1 shows a computer system for interacting with an image according to an example. In FIG. 1, a client computing device 101 is communicatively coupled to a server computing device 105. The client computing device 101 may be a wired and/or wireless device. It may also be a telecommunications device. The server computing device 105 may also be a wired and/or wireless device, and may be coupled to a telecommunications network. In FIG. 1, the client computing device 101 is communicatively coupled to the server computing device 105 via one or more networks 103. These networks may comprise telecommunications networks. They may, as well or alternatively, comprise a network of one or more local and/or wide area networks. This network may be the Internet as referred to in the art. In certain embodiments, additional components such as a load balancer 104 may be provided between the client computing device 101 and the server computing device 105. Load balancer 104 may act to distribute network traffic to a particular server computing device in a plurality of server computing devices depending on network load.

In FIG. 1, the client computing device 101 implements a client browser 102. For example, the client computing device 101 may comprise at least one processor and a memory, wherein computer program code loaded into memory and processed by the at least one processor implements the client browser 102. Similarly, in FIG. 1 the server computing device 105 implements an application server 106. For example, the server computing device 105 may comprise at least one processor and a memory, wherein computer program code loaded into memory and processed by the at least one processor implements the application server 106. In use, the client browser 102 is arranged to access the application server 106 by way of the one or more networks 103. In one case, the client browser 102 may comprise an Internet browser such as Internet ExplorerTM from Microsoft Corporation, Chrome™ from Google Incorporated or Safari™ from Apple Corporation. On a mobile device such as a smartphone the client browser 102 may comprise a suitably adapted mobile browser. In other examples, functionality of the client browser 102 may be incorporated into a dedicated application (e.g. “app”) that is implemented by the client computing device 101. Client browser 102, or its equivalent, provides one or more user interfaces for accessing an application provided by the application server 106. For example, the client computing device 101 may comprise a display and at least one input device. A user may use the input device to interact with a user interface provided by the client browser 102 that is shown on the display.

The application server 106 implements an application. In one example, this application may comprise a web server, in which case application server 106 provides data in the form of HyperText Markup Language (HTML) pages and/or page components to the client browser 102. In another example the application server 106 may provide data to an application running on the client computing device 101, wherein the data is processed by the client computing device 101 and rendered on an associated display. Similarly the application server 106 is arranged to receive requests from the client computing device 101 in response to user interactions applied via an associated input device. In providing an application to a user of the client computing device 101, the application server 106 may be communicatively coupled to one or more of a media server 107 and a database 108. Media server 107 may be arranged to store one or more images for use by the computing system. Database 108 may comprise a relational database containing data for implementing the application, for example data associated with a particular user and a particular session. In one case, application server 106 comprises a server computing device arranged to provide digital content, e.g. page components, for a web page. For example, application server 106 may be arranged to provide an application in the form of an interactive advertisement for a web page. This web page may be a web page that is not supplied by application server 106. The page component that hosts the application may comprise, amongst others, a banner, a pop-up component, a framed portion of HTML, a floating or overlaid page component, an expanding or dimensionally-variable page component, an interstitial page component and a portion of a dedicated application or “app”.

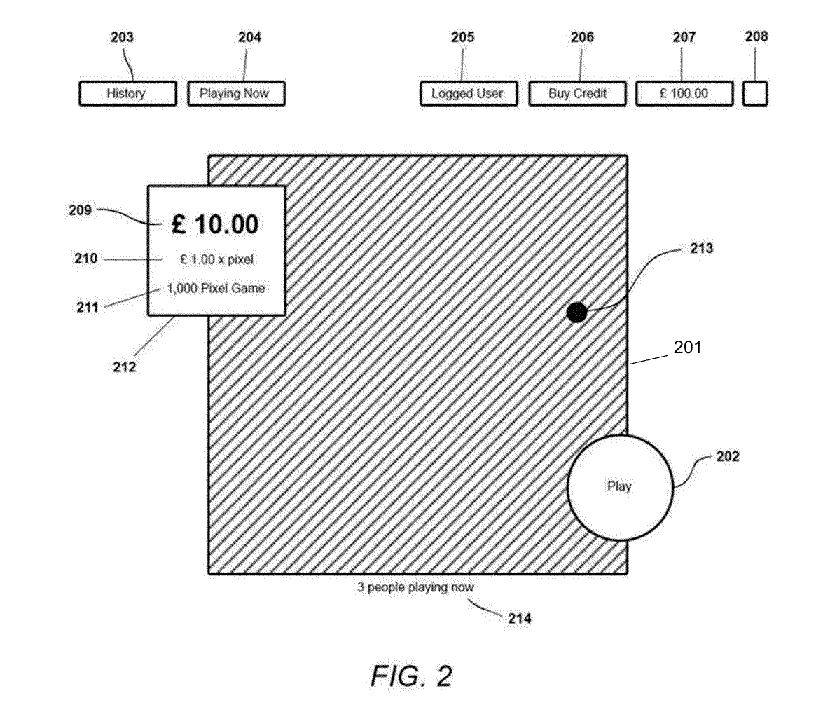

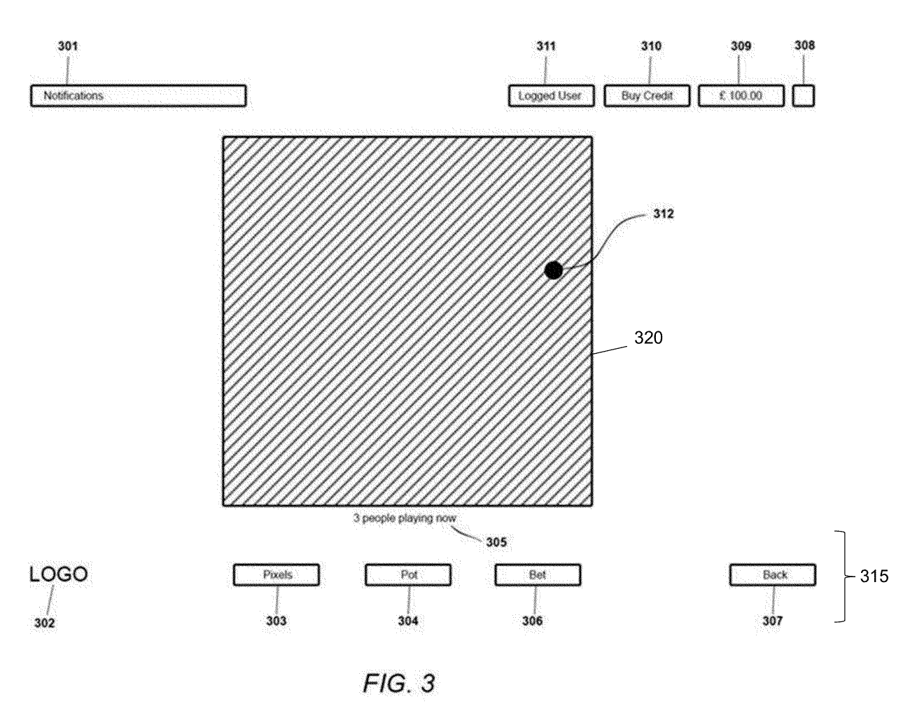

An application provided by the application server 106 to a user of the client computing device 101 will now be described with reference to the example user interfaces of FIGS. 2 and 3. It should be noted that the user interfaces of FIGS. 2 and 3 are provided as examples only to better described the functionality of certain embodiments described herein. In other examples, user interface components may be added, modified and/or omitted in correspondence with the requirements of the implementation. FIG. 2 is a schematic diagram showing a first user interface. The user interface may be provided within a window or tab of client browser 102. Alternatively, it may comprise a user interface provided by an application operating on the client computing device 101. This user interface may be displayed to a user via a display. The user may interact with the user interface using one or more input devices, e.g. a mouse, a keyboard and/or a touch-screen.

In FIG. 2 the application provided by the application server 106 is an online game. On the user interface an image 201 is displayed to the user. This image may be loaded from the media server 107. The image may be any image of a configurable size. The user is offered the ability to commence a game session based on the image 201. If the user wishes to commence a game session, they activate “play” user interface component 202 and start a game. A user may also log-in, for example be authenticated by the application server 106 using the database 108. A log-in status of a user may be displayed by “log-in status” user interface component 205—for example this may display a name of a logged in user. A “log-off” user interface component 208 may also be provided to allow a user to log out of a game session and/or a session with application server 106. A user may log-in to a session with the application server 106 via an initial authentication procedure wherein the user enters a username and password. In other examples, e.g. where the online game is provided as a page component, the online game may comprise the image 201 without the other user interface components shown in FIG. 2. The online game may be provided as a portion of any digital media.

In a game session at least one pixel in the image 201 is set as a winning pixel. For example, the co-ordinates of one or more pixels may be stored during the set-up of a game session. The game session may also be referred to as an interaction session. These one or more pixels are set as predetermined pixels (so-called “winning” pixels). They may be selected at random. During a game session a user selects at least one pixel in the image 201. The application server 106 then determines whether the at least one selected pixel comprises the one or more predetermined pixels. Responsive to a determination that the at least one pixel comprises said at least one predetermined pixel, a reward item is assigned to the user by the application server 106. Responsive to a determination that the at least one pixel does not comprises said at least one predetermined pixel, the reward item is not assigned to the user. In this latter case the application server 106 may record that the at least one pixel is not available for selection by the user. This may be indicated to the user on at least a version of the image that is displayed on a display of the client computing device 101.

In the example of FIG. 2, each pixel selection by a user has an associated cost. In FIG. 2, this cost is displayed to the user via “cost” user interface component 210 of FIG. 2. In the example of FIG. 2, the selection of one pixel costs 1 monetary unit (£1). The number of monetary units per pixel may be configurable by an application administrator. Each user has an associated user account. This user account may be implemented by way of user data stored in database 108. In FIG. 2 a user account has an associated amount of credit. This credit may be bought, for example, with a credit or debit card, bank transfer or online payment such as Paypal™. FIG. 2 shows that the current user has a credit balance in their user account of 100 monetary units (£100). This is shown by “balance” user interface component 207. In certain embodiments, a user account may be allowed to have debit balance of a predetermined value. A payment or account credit may be required when a balance associated with a user account falls below a predetermined threshold. FIG. 2 shows a “payment” user interface component 206 that a user may activate to arrange a payment or credit. In one example, the credit balance of 100 monetary units for the user account could allow 100 pixel selections as part of a game session. In certain embodiments there may be a definable discount for a plurality of selections activated at one time, e.g. a user may be able to use 10 monetary units for 15 pixel selections as part of a predefined offer. In other examples, pixel selections may be limited by other methods. For example, a pixel selection may be limited by an identifier associated with client computing device 101 and/or client browser 102. This identifier may comprise a network address such as an Internet Protocol address and/or a unique user identifier, e.g. such as a cookie or the like. In these examples, the cost may be seen as the number of interactions that are assigned to each user, e.g. a user having a given identifier may be assigned a configurable number of interactions or “clicks”, such as between 1 and 10.

In FIG. 2, each game session is associated with an accumulated monetary amount. This accumulated monetary amount is representative of a plurality of debits from one or more user accounts. Every time a user makes a pixel selection the associated cost of that selection is debited from their user account and at least a portion of that cost is added to the accumulated monetary amount. The accumulated monetary amount may thus represent a particular percentage of all the monetary amounts debited from one or more user accounts. In FIG. 2 the accumulated monetary amount is shown by “pot” user interface component 209. “Pot” user interface component 209 is shown in FIG. 2 in a user interface pane 212 together with the “cost” user interface component 210 representing the cost of a pixel selection and a “pixel-count” user interface component 211 representing the number of selectable pixels in the image 201. If a user selects a predetermined winning pixel then the accumulated monetary amount as illustrated by the “pot” user interface component 209 is assigned as the reward item to the user account. In one example, the reward item may be assigned to the account balance displayed by “balance” user interface component 207. A user may then have an option to transfer at least a portion of this account balance to a bank account and/or to exchange a balance amount for goods and/or services.

A game session may be attended by a plurality of users. In this case the client computing device 101 may form part of a plurality of client computing devices. These client computing devices may be homogeneous or heterogeneous. Each user may use a different method to attend the game session, e.g. some users may access the game session via a client browser while other users may access the game session via a dedicated application. The application server 106 may monitor the number of users in a game session, e.g. the number of logged-on users who have clicked on the “play” user interface component 202 for a particular image 201 and/or the number of unique identifiers associated with users and/or their devices. In FIG. 2, the number of users in the present game session is displayed to the currently logged-in user via “players” user interface component 214. In examples with non-monetary costs, the reward item may be dependent on the number of unique users that interact with the image 201.

In one implementation, a pixel that is not a predetermined winning pixel may be independently selectable by each of a plurality of users. For example, in a game session, each pixel that is selected by a user may be displayed to that user as “selected-pixel” user interface component. For a game session for a particular user there may be a plurality of “selected-pixel” user interface components representing all non-winning pixels that have been selected by the user. These “selected-pixel” user interface components may not be visible to other users; hence, multiple users may each select a common non-winning pixel. This can enable a larger accumulated monetary amount per image 201. When a particular user selects a winning pixel this may terminate a game session for all active users. Inactive users, e.g. those not logged in at the present time, may be informed by a suitable electronic message. A winning user may be displayed on the user interface in certain cases and/or game session information (as shown by user interface pane 212) at the time of a winning pixel selection. For example, a message may be displayed in association with the image 201 indicating a winning user.

In one implementation each user may link a social media account to their user account and/or an interaction session. A user may thus be able to see data relating to users that have associated social media accounts. For example, a social media account may have a number of linked social media accounts (e.g. “friends” or “followers”). User accounts associated with these linked social media accounts may be determined. Usernames and/or other user data associated with these user accounts may then be displayed to a logged-in user by way of “playing now” user interface component 204. For example, game sessions featuring “friends” of a user may be displayed by clicking on “playing now” user interface component 204. A logged-in user may also be able to send one or more messages to the said linked social media accounts informing them of the game session currently attended by the user. In one case, if a user sets up a user account and/or accesses a game session based on such messages, the user account of the user who instructed the sending of the messages may be credited with a predetermined monetary amount. In other examples that do not require a “log-in” process, authentication for a social media account may be provided to enable a user to communicate a state of their interaction with the image with other social media users. A user may be assigned additional interaction sessions and/or cost credits if they communicate a state of their interaction, e.g. that they have interacted with the image and/or located a winning pixel.

A user may also be able to access a record of their interactions with the application server 106. For example, “history” user interface component 203 may display at least a portion of said interactions. In other cases this may be available through a dedicated application, e.g. on a mobile device. In certain case it may also show interactions of linked users. For example, a user may be presented with at least a list of previous game sessions. By selecting an item in this list a user may be taken to a particular gaming session associated with a particular image. In one case a user may be able to select areas of the user interface to the left and/or the right of the image 201 to view other images. A game session associated with a particular image is then accessed by selecting the “play” user interface component 202. For example, in a touch-screen case a user may swipe left and/or right to view other images (together with user interface pane 121 showing game session information) and then select an image by touching an area of a screen associated with the “play” user interface component 202.

In certain implementations, as well as the predetermined “winning” pixels described above one or more sets of one or more pixels are set as “bonus” pixels. As for the “winning” pixels, these “bonus” pixels may be predetermined using a random number generator, e.g. a random number generator that selects a pixel co-ordinate comprising a pixel row and a pixel column When a user selects a pixel that is predefined as a “bonus” pixel a bonus item may be assigned to the user. This bonus item may comprise a percentage of the accumulated monetary amount and/or additional prize items. These prize items may comprise, amongst others, pixel selection credits, physical and virtual goods and/or discount vouchers or voucher codes. In most cases a bonus pixel is not a winning pixel, as such selection of a bonus pixel by a user does not terminate a game session. In certain cases bonus pixels and winning pixels may form part of a common group. In this case, there may be an unknown number of pixels that assign a reward item to a user on selection. In one case, a game session may only terminate when all pixels have been selected by one or more users.

In one implementation, a user may be presented with a main image 201 yet have the opportunity to navigate to another image. For example, a user may click to one side of the image 201 to view other images, e.g. navigate in one or more of the following directions to the left of image 201, to the right of image 201, above image 201 or below image 201. In one case several images and/or portions of other images may be visible to a user. In one case, any one or more of user interface components 202 or 209 to 212 may not be visible until a user activates an image, e.g. by touching and/or holding a finger over the image when using a touchscreen or via a mouse “hover on” event. In one case, an application may enable a user to navigate between different page components that contain an interactive image.

In one implementation, one or more pixels that have been selected by one or more users may be displayed as an area of solid fill of a predetermined color when viewing image 201. For example, in FIG. 2 pixel 213 has previously been selected by a user. This is indicated by changing the color value of the pixel to black (e.g. a Red, Green, Blue—RGB—value of 0, 0, 0). Two or more of winning pixels, bonus pixels and non-winning pixels may be set to the same color or to different colors. In one implementation, both bonus pixels and non-winning pixels are set to one color when viewing an image 201, e.g. via the user interface shown in FIG. 2. However, when a user enters a game session (e.g. by clicking on an image), bonus pixels and non-winning pixels are set to different colors (e.g. white and black respectively).

FIG. 3 shows a user interface that may be displayed to a user in a game session. The user interface of FIG. 3 may be displayed to a user following selection of the “play” user interface component 202. In other examples, the game session may comprise image 320 within a page component. Within a game session, as shown in FIG. 3, a user cannot select and/or view other game sessions featuring other images. In the user interface of FIG. 3, a user is again presented with a “log-off” user interface component 308 (similar to user interface component 208 in FIG. 2), a “balance” user interface component 309 (similar to user interface component 207 in FIG. 2), a “payment” user interface component 310 (similar to user interface component 206 in FIG. 2) and a “log-in status” user interface component 311 (similar to user interface component 205 in FIG. 2). At least user interface components 308 to 311 and 205 to 208 may form part of a common tool bar that is visible to a user across multiple user interfaces. In FIG. 3, there is also a “notifications” user interface component 301. This component 301 may display one line text notifications to a logged-in user, for example notifications regarding the activity of linked users as described previously.

The user interface of FIG. 3 also comprises a lower toolbar 315. In the present example the lower toolbar comprises a logo 302 and four user interface components 303, 304, 306 and 307. A “pixel-count” user interface component 303 is similar to “pixel-count” user interface component 211 in FIG. 2. A “pot” user interface component 304 is similar to “pot” user interface component 209 in FIG. 2. A “cost” user interface component 307 is similar to “cost” user interface component 210 in FIG. 2. A “back” user interface component 307 enables a user to exit a game session and return to the user interface of FIG. 2. A “players” user interface component 305307 is similar to “players” user interface component 214 in FIG. 2. As described previously, these user interface components may vary depending on the implementation, e.g. zero or more components or variations on the components may be displayed in addition to image 320.

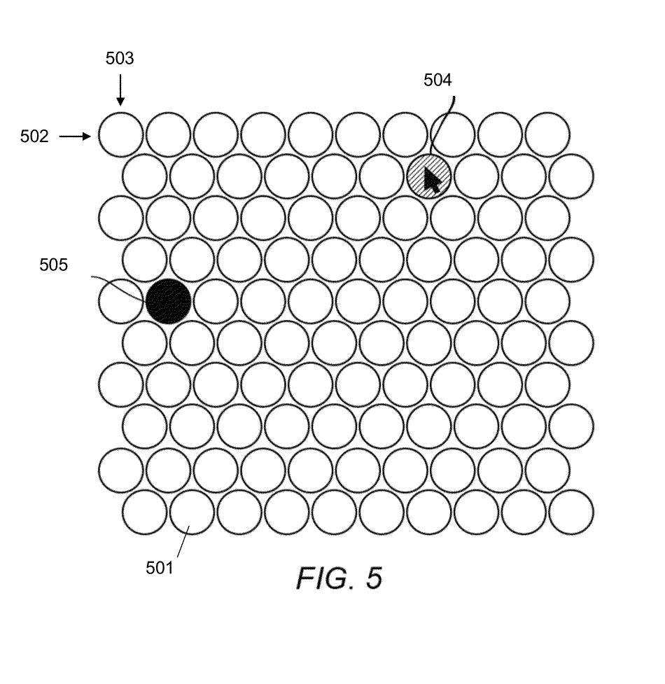

FIG. 5 shows an example of image 320 in FIG. 3 in more detail. FIG. 5 shows at least a portion of a plurality of pixels 501 of an image. Pixels may be organized in pixel rows 501 and pixel columns 503. FIG. 5 shows an example of a user selecting a non-winning pixel 504. The pixel 504 is selected by a user activating an area associated with the pixel 504. In one case an image may be expanded to ease selection of individual pixels. For example, each pixel may be enlarged to encompass an area comprising a plurality of pixels of a user display. In one case, a pixel may be expanded to comprise a circular area of color equal to the color value of the pixel. For example, if an original image is a 20 by 20 pixel image (400 pixels in total) in a game session mode, an enlarged version of the image may be generated wherein each pixel is enlarged to be a 3 by 3 or 5 by 5 area of solid color (e.g. in a 60×60 or 100 by 100 image). These enlarged pixel areas associated with a pixel of a game session image 301 enable a user to easily select a pixel with an input device such as a mouse or a touch-screen. After a selection has been made a pixel or pixel area may be marked, for a particular logged-in user, as having been selected. For example, in FIG. 5 a selected pixel 504 is greyed out following selection. An icon such as a cross may also be added to a pixel or an enlarged pixel area. FIG. 5 also indicates the position of a winning pixel 505 (which is not shown to a user). If this pixel 505 is selected and the game session ends with the assignment of a reward item, the pixel or pixel area may be enlarged so that a user can view selected and winning pixel(s) for a terminated game session.

In one implementation, a number of selectable pixels for an image may differ from the number of pixels in the image. In this case, an image is divided into a number of pixel groups. This may be performed by application server 106. For example, an image of 800 by 600 pixels (480000 pixels) may be divided into 1000 selectable pixel groups of 24 by 20 pixels. One of these 1000 selectable pixel groups may then be predefined, e.g. randomly selected, as a winning pixel group. In this case the application server receives a selection of at least one pixel and determines which pixel group this selection corresponds to. One a selected pixel group is determined this is compared with the predefined winning pixel group as described for individual pixels above. The number of pixel groups for an image may be configurable by an application administrator. An application server 106 may also host game sessions with a plurality of different pixel group sizes. In one case, there may be multiple game sessions with different pixel group sizes that all share a common underlying image.

References made to “pixels” in this description should be interpreted as also applying to pixel groups; e.g. in certain implementations a winning pixel may comprise a winning pixel group etc. As such “pixel” refers to any selectable portion of an image or image layer. For example, each “pixel” 501 in FIG. 5 may comprise a pixel group centered on an actual pixel of the image. Not all pixels in an image may have an associated pixel group. For example, if an image of 800 by 600 pixels is divided into 1000 selectable pixel groups, only 1000 pixels of the image may have an associated pixel group. A pixel group may be represented by an area superimposed on an underlying image. This area may be filled with a block of color that derives a value from a central pixel yet be semi-transparent, e.g. have a solid-fill with an RGB value derived from a central underlying pixel and a transparency value of between 20% and 80%. The area may be a particular shape, e.g. circular, rectangular or square. If the area is circular the underlying image may be visible in the gaps between pixel groups, e.g. in the area between “pixels” 501 in FIG. 5. In this case not all pixels of an underlying image may form part of a corresponding pixel group. When a user interacts with a pixel group, e.g. presses on a touchscreen area corresponding to the group or hovers a mouse pointer over the group, the area may be enlarged and/or set to have a modified transparency value (e.g. set to opaque). In a case where the number of selectable pixel groups equals the number of pixels in an image, the two implementations converge. In examples, the number of selectable elements in an image may be configurable, e.g. from one hundred pixels or pixel groups to over a million.

In one case an image such as 201 may have a number of representations or versions. For example, there may be an underlying layer or image upon which pixel groups are displayed as areas. The areas may thus form a further layer or image on top of the underlying layer or image. Different implementations may use different computer graphic functions to provide the functionality described herein.

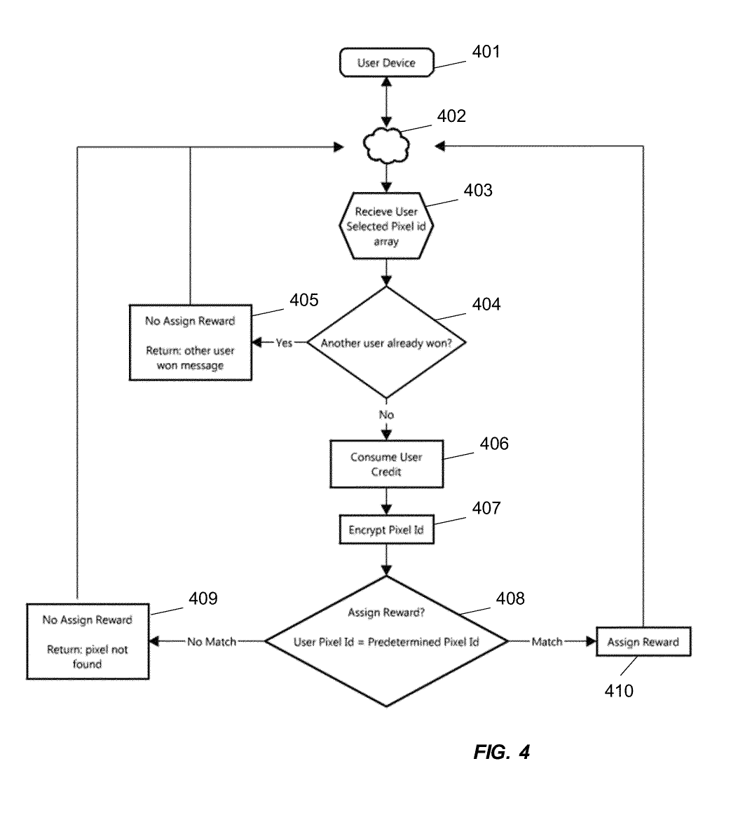

FIG. 4 shows an example method that may be used to interact with an image. The method of FIG. 4 may be implemented on the computing system of FIG. 1 using the user interfaces of FIGS. 2 and 3. In block 401 a user operates a user device or terminal This may be client computing device 101. At block 402 the user communicates with a computing device hosting an interaction session. This may comprise an application server 106 hosting a game session as described previously. In FIG. 4 the user in an interaction session selections at least one pixel. At block 403 an identifier (ID) for the selected at least one pixel is received. For example, a client browser 102 or other client-side application may determine a co-ordinate or a unique pixel ID for a selected pixel. This may then be sent to application server 106. At block 404 a check is made to determine if a winning pixel has already been selected by a user. If this is the case then at block 405 no reward item is assigned to the user and a message is returned to the user indicating that the game session is terminated. If a winning pixel has yet to be selected then the method proceeds to block 406. At block 406 a user credit is debited from a user account. This may be performed by application server 106 in operation with database 108. The user credit may be a monetary amount or other form of credit. For example, a user credit may be a counter indicating the number of times that a user has interacted with the image. If a user has suitable credits and at least one of these can be debited then, following the debit of a user credit an encrypted winning pixel identifier is retrieved at block 407. A pixel ID of a winning pixel may be encrypted for security. A winning pixel identifier may also represent a winning pixel group if these are being implemented. At block 408 the encrypted winning pixel identifier is compared with the selected pixel or pixels received from the user. In one case the encrypted winning pixel identifier is decrypted and securely compared with the selected pixel or pixels. In another case the selected pixel may be encrypted and compared with the encrypted winning pixel identifier, e.g. a one-way hash function may be used and the result of the hash function compared. If there is no match then at block 409 no reward item is assigned and the user is notified accordingly. If there is a match then at block 410 a reward item is assigned to the user. This may terminate the game session.

In one variation of the described examples, a reward item may comprise a prize and/or product associated with a company and/or brand, e.g. as well as or instead of an accumulated monetary amount. In this case, an image associated with a game session may comprise an image of the prize and/or product. For example, a reward item may comprise a new tennis shoe provided by a particular company and/or brand. An image of the reward item is obtained and divided into a predetermined number of pixel groups. Users may then receive one or more credits as part of a promotion, e.g. as part of a marketing promotion or via an associated product purchase. Users may then redeem these one or more credits via branded user interfaces. A user may be limited to a particular number of credits, i.e. be limited to a particular number of pixel or pixel group selections. In another case a user may be limited to one or more of a particular number of clicks and a particular time period for selecting pixels or pixel groups. If a user selects a randomly predefined pixel or pixel group, the prize and/or product may be sent to a recorded and/or entered user address. Digital or material promotion literature may reference a uniform resource locator associated with one or more of the application server 106 and a particular game session. For example, a car manufacturer may provide a link to a game session featuring a new model of car in a promotional email or other electronic message. Additionally, a user may redeem a credit using a predefined code, e.g. a code located on an associated product, and/or using an identifier such as an IP address or cookie identifier. In one case the prize may comprise tickets to a particular event wherein the image is an image associated with the event. A development toolkit may be provided to organizations to build their own application server or make use of a hosted application server to generate and initialize one or more game sessions. In certain implementations reward items may comprise, amongst others, airline fares, hotel packages, sports events, etc.

In certain examples, a game session may have a cost of pixel selection that does not directly comprise a monetary amount. For example, game session credits may comprise reward credits from reward schemes such as air miles, credit card reward schemes, membership schemes and shopping schemes. In one case credits may be user-definable. For example a user may create a private game session with N selectable pixels or pixel groups. The user may then distribute at least a portion of N credits to one or more users. Only users receiving a set of one or more N credits may participate in the private game session. In one case, the image may comprise an image of an item a user wants to dispose of, such as an item of furniture or other second-hand good. In one case, a user may create a game session as a private or public lottery. In this case, the user sets a cost or price for each pixel or pixel group selection. The winning pixel is then associated with a reward item for the lottery. Again, the image may be an image of the reward item. In this case an accumulated monetary amount is assigned to the user that created the game session and the “winning” user is assigned the reward item. In this manner, a user may sell a product or second-hand item.

In one variation of the above-described examples a user is offered a “share mode” of operation. For example, a “share mode” of operation may be selected via a settings menu and/or a user interface component. In this mode a number of pixel selections for a plurality of users are recorded by the application server 106. In certain implementations all pixel selections may be recorded by default and stored in database 108. If a “share mode” is activated for a particular user then if the user selects a winning pixel or pixel group then a reward item and/or a set of bonus items are shared between the particular user and other users that share one or more game session metrics. For example, one game session metric may comprise the number of non-winning pixel selections within a game session. If a winning user has previously selected 5 non-winning pixels then all other users that have also previously selected 5 non-winning pixels share the reward item with the winning user. Alternatively all these users may be assigned a bonus item. Another game session metric may comprise shared pixel selections, i.e. a reward item is shared with users that have also selected at least one non-winning pixel previously selected by the winning user. In one case a particular portion or percentage of the reward item is assigned as a “share prize” to be assigned to other users, e.g. 10% or 20%.

As described herein a client computing device as used in this specification may comprise a telecommunications device that includes but is not limited to the following: (a) wired and wireless personal communication devices, (b) electronic devices configured to share content in a local area network (LAN), (c) electronic gaming devices, (d) any machines configured for wireless communications in a home or office application (so-called smart devices). A client computing device may also or alternatively comprise a “wireless devices” that includes in general any device capable of connecting wirelessly to a network, and includes in particular mobile devices including mobile or cell phones (including so-called “smart phones”), personal digital assistants, pagers, tablet and laptop computers, wearable communication devices, content-consumption or generation devices (for music and/or video for example), as well as fixed or more static devices, such as personal computers, game consoles and other generally static entertainment devices, and various other domestic and non-domestic machines and devices.

In the described examples a user interface may be displayed on a display and be manipulated by an input device in communication with a processing system of a client computing device to receive an indication of a user input. A user input device may include, for example, a keyboard, a mouse, a joystick, a trackpad, a touch screen and/or other input/output mechanisms. The user interfaces described herein are for example only and may be modified, extended and/or otherwise changed depending on a particular implementation. For example, user interface components may be added, omitted, merged and/or otherwise modified based on the implementation.

In one variation, a computing system comprises a server computing device as described herein together with a plurality of user computing devices, a user computing device comprising a display device arranged to display a representation of the image to a user, an input device for use in selecting, by the user, at least one pixel associated with the image and a network interface arranged to communicatively couple the user computing device to the server computing device via one or more networks.

In one variation, each user selects a group to join from a plurality of groups. In one case, there may be two “rival” groups. In other cases there may be more than two groups. Each group may be indicated by a further user interface component displayed via the user interface of FIG. 2, e.g. in opposing corners of an image 201. In a game session, e.g. via the user interface of FIG. 3, a user may select a group by activating (e.g. by clicking or touching) one of a plurality of user interface components indicating the available groups. A set of groups may be unique to and/or associated with a particular image. For example, a picture of a soccer match may have two groups representing the soccer teams competing in the match. In the present variation, each group has a collective account, wherein reward items are assigned to the collective account rather than a user's individual account.

In one implementation, there are a plurality of winning and/or bonus pixels or pixel groups. For example, there may be a plurality of winning pixel types, each winning pixel type assigning a particular monetary amount as a prize. One or none of these winning pixel types may terminate a game (e.g. a game may continue until all pixels have been selected). In one case, any selections may result in some form of reward item, however this reward item may be less than the cost of a selection.

In the variation described above, reward items are assigned to the collective account of a user's group. For example, any monetary amounts may be recorded as contributing to a central “pot” for the group. If a user selects a wining pixel or pixel group that terminates a game session, then the reward item assigned to the user may comprise at least a portion of one or more other groups “pots” (e.g. at least a portion of a monetary amount in a collective account of each group that is party to a game session, a “rival's pot”). In one case, any selection costs incurred by users in the same group (i.e. the “winning group”) are refunded. In effect, in this case, a user only incurs a net cost if a user of a group other than a group they belong to selects a winning pixel or pixel group, i.e. a user only “loses” if a user of a rival group “wins”.

Although at least some aspects of the examples described herein with reference to the drawings comprise computer processes performed in processing systems or processors, the invention also extends to computer programs, particularly computer programs on or in a carrier, adapted for putting the examples into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that a processor or processing system or circuitry referred to herein, e.g. that implementing a client and/or server computing device may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, which are configurable so as to operate in accordance with the examples. In this regard, the examples may be implemented at least in part by computer software stored in (non-transitory) memory and executable by the processor, or by hardware, or by a combination of tangibly stored software and hardware (and tangibly stored firmware).

The above examples are to be understood as illustrative. Further examples are envisaged, such as those described above. Additionally, even though the examples have been described in the context of an online client-server system they may be adapted for an offline implementation, e.g. where the client and server computing device comprise a common device. It is to be understood that any feature described in relation to any one example or Figure may be used alone, or in combination with other features described, and may also be used in combination with one or more features of any other of the examples or Figures, or any combination of any other of the embodiments. Furthermore, equivalents and modifications not described above may also be employed without departing from the scope of the invention, which is defined in the accompanying claims.

What is claimed is:

1. A computer-implemented method comprising:
receiving, at a computing device, a selection corresponding to at least one pixel in an image by a user, the image being displayed on a display device accessible to the user, the selection being performed using an input device accessible to the user;
determining, at the computing device, if the selection corresponds to at least one predetermined pixel in the image; and
responsive to a determination that the selection corresponds to said at least one predetermined pixel, assigning a reward item to the user,
wherein responsive to a determination that the selection does not correspond to said at least one predetermined pixel, the reward item is not assigned to the user.

2. A computer-implemented method according to claim 1, comprising:
before receiving a selection corresponding to at least one pixel in an image by a user, establishing an interaction session corresponding to the image at the computing device,
wherein responsive to a determination that the selection corresponds to said at least one predetermined pixel ending the interaction session.

3. A computer-implemented method according to claim 1, comprising:
responsive to a determination that the selection does not correspond to said at least one predetermined pixel, recording, at the computing device, that an image portion corresponding to the selection is not available for further selection by the user and indicating this to the user on at least a version of the image displayed on the display device.

4. A computer-implemented method according to claim 1, comprising:
in association with the selection corresponding to said at least one pixel in the image by the user, debiting an account associated with the user by a predetermined amount.

5. A computer-implemented method according to claim 4, wherein the account comprises one or more of: a monetary account; a reward scheme account; and a user account associated with a specific interaction session.

6. A computer-implemented method according to claim 4, wherein the computer-implemented method is repeated for a plurality of users and further comprises:
accumulating a plurality of predetermined amounts, the predetermined amounts being debited from a plurality of accounts associated with a plurality of users,
wherein the reward item comprises at least a portion of the accumulated amount.

7. A computer-implemented method according to claim 1, wherein the image comprises an image of the reward item.

8. A computer-implemented method according to claim 1, comprising:
receiving, at the computing device, the image;
dividing, at the computing device, the image into a predetermined number of selectable portions; and
assigning, at the computing device, at least one selectable portion corresponding to the image as said at least one predetermined pixel,
wherein receiving, at the computing device, the selection corresponding to the at least one pixel comprises receiving a selection of a selectable portion, and
wherein determining, at the computing device, if the selection corresponds to the at least one predetermined pixel in the image, comprises determining if the selected portion comprises the selectable portion assigned as said at least one predetermined pixel.

9. A computer-implemented method according to claim 1, comprising:
recording, at the computing device, a number of selections received for each of a plurality of users;
receiving, at the computing device, an indication that a share mode of operation has been selected by a current user; and
responsive to a determination that the share mode of operation has been selected by the current user and a determination that the selection corresponds to said at least one predetermined pixel, assigning a portion of the reward item to each user that has a number of selections equal to a number of selections of the current user.

10. A computer-implemented method according to claim 9, wherein a portion of the reward item is only assigned to a user in the plurality of users if the computing device has received an indication that said user has also selected a share mode of operation.

11. A computer-implemented method according to claim 1, wherein the image comprises a plurality of pixels and said at least one predetermined pixel is at least one pixel that is randomly selected from said plurality of pixels.

12. A computer-implemented method according to claim 1, comprising:
responsive to a determination that the selection does not correspond to said at least one predetermined pixel, determining, at the computing device, whether the selection corresponds to at least one bonus pixel; and
responsive to a determination that the selection corresponds to at least one bonus pixel, assigning a bonus item to the user.

13. A computer-implemented method according to claim 1, wherein:
the computing device is communicatively coupled to at least one network;
a plurality of user terminals are communicatively coupled to the computing device through the at least one network, each user terminal comprising at least a display device and an input device; and
the computer-implemented method is repeated for a plurality of users, a user making use of a respective user terminal.

14. A computer-implemented method according to claim 13, comprising:
sending, to a user terminal, a number of users from which the computing device has received a selection for a particular image, said number being displayed on the display device of the user terminal.

15. A computer-implemented method according to claim 13, wherein at least one pixel that does not comprise said at least one predetermined pixel is independently selectable by each of the plurality of users.

16. A computer-implemented method according to claim 13, comprising:
assigning a reward item to the user further comprises terminating the computer-implemented method for the plurality of users.

17. A computer-implemented method according to claim 13, comprising:
associating, at the computing device, a first user with a second user; and
sending, for display on a display device of a user terminal associated with the second user, an indication that at least one pixel selected by the first user does not comprises said at least one predetermined pixel.

18. A computer-implemented method according to claim 13, wherein:
each users selects a group from a plurality of groups; and
assigning a reward item to the user further comprises assigning a reward item to each user in the group associated with the user.

19. A method comprising:
receiving data representative of an image from a server computing device;
displaying, based on the received data, a representation of the image on a display device associated with a user computing device;
receiving, from an input device associated with the user computing device, a selection corresponding to at least one pixel in the image by a user, the selection being made in relation to the displayed representation;
sending, from the user computing device to the server computing device, data representative of the selection; and
receiving data from the server computing device indicative of whether the selection corresponds to at least one predetermined pixel in the image, including receiving data indicative of an assignment of a reward item to the user if the selection corresponds to said at least one predetermined pixel in the image.

20. A computing system comprising:
a server computing device communicatively coupled to a computer-readable storage medium and comprising an interface to receive data indicative of a selection corresponding to at least one pixel from a user, the server computing device having access to data representative of an image, said data being stored on the computer-readable storage medium and comprising an indication of at least one predetermined pixel in the image,
the server computer device being arranged to determine, based on the data stored on the computer-readable storage medium, if received data indicative of a selection corresponding to at least one pixel from a user comprises a selection corresponding to said at least one predetermined pixel in the image, and to, responsive to a positive determination, send data to the user indicating that they have been assigned a reward item.
